(19) United States
(12) Patent Application Publication
(10) Pub. No.: US 2023/0259998 A1
(43) Pub. Date: Aug. 17, 2023

(54) SYSTEM AND PROCESS FOR ESTIMATING A CABINET INSTALLATION

(71) Applicant: operateIT, Inc., Ronkonkoma, NY (US)

(72) Inventors: Keith T. TOBIAS, Mastic Beach, NY (US); Christopher E. PATTERSON, Patchogue, NY (US)

(73) Assignee: operateIT, Inc., Ronkonkoma, NY (US)

(21) Appl. No.: 18/106,012

(22) Filed: Feb. 6, 2023

Related U.S. Application Data
(60) Provisional application No. 63/307,156, filed on Feb. 6, 2022.

(51) Int. Cl. G06Q 30/0601; G06Q 30/0283; G06Q 30/0203

(52) U.S. Cl. CPC G06Q 30/0621; G06Q 30/0203; G06Q 30/0283

(57) ABSTRACT

At least one embodiment of the invention relates to a process for estimating a cabinet installation comprising a series of steps. This includes creating a cabinet brand, creating a pre-set set of layouts. The user then inputs the dimensions and is then provided with an array of suitable layouts based upon the dimensions. Once the user selects a layout and among different brands, the system then creates cost options for furnishing a layout with cabinets.

### CROSS REFERENCE TO RELATED APPLICATIONS

This application is a non-provisional application 63/307,156 filed on Feb. 6, 2022, the disclosure of which is hereby incorporated herein by reference in its entirety.

### BACKGROUND

One embodiment relates to an estimating system and process for estimating the cost of a layout of cabinets in a construction space. Currently, when one looks to estimate for a kitchen or bathroom renovation, the estimator would take many hours and several meetings to provide this type of estimate. For example, in the past it may take an estimator 6-8 hours of time to estimate the cost for a kitchen and bathroom renovation. In addition, if there are any changes as well as inaccuracies in the estimate, the amount of the estimate could be inaccurate as well. The delays in providing an estimate as well as the need for a rapid estimate that can be used to start a kitchen and bathroom project.

Therefore, there is a need for a rapid estimating system which can be used to provide estimates rapidly and accurately for contractors or estimators for a construction project such as a kitchen and bathroom renovation.

### SUMMARY

At least one embodiment relates to a cabinet selector which is a cloud-based tool built for the residential construction trades. This tool provides residential designers/renovators a personalized experience in rapidly obtaining cabinets and layouts for cabinets based upon three basic grades good, better and best. There are then comparative cost options for custom cabinetry without the need of formal design or estimate.

What has previously taken 6-8 hours per project to formulate, this type of design allows sales agents and designers to indicate in a provided interface various standardized characteristics such as wood species, finish, construction, drawer construction, box material, cabinet style, drawer front, door style and insert modifications and instantly receive realistic, personalized cost-ranges back across numerous cabinet brands without ever having to do a detailed estimate or quote.

There are 4 major components of the Cabinet Selector setup. For example, the first component includes a back-end cabinet replicator. This cabinet replicator provides a sample floor plan, displaying a combination of various cabinet types (Base, Drawer base, Wall, Tall, Panel, Post and Trim and Hood). This floor plan is replicated using any custom cabinet brand’s catalog. An algorithm is applied to summarize like cabinet types and reach a blended cost value. These are referred to as “calculated cabinet raw costs”. These calculated raw costs are list costs for the cabinet type prior to dealer factor personalization applied.

A second component includes a back-end brand characteristic catalog. The cabinet brand characteristics provides a digital form in which each modification option provided by the Brand being provisioned is entered as a standardized value. This applies to each of the characteristics defined in the bullet above. Each characteristic is added along with its option cost factor. An option cost factor is a decimal number that is multiplied by to reach the modified cost of a cabinet. For example, a cabinet brand may have a painted finish option called “matte finish”. That option is added into the “Finish” column of the Cabinet Brand Characteristics as “Painted Finish” with a cost factor of “1.56”. If being applied to a Base Cabinet with a raw cost of $275, adding a painted finish to this cabinet would bring its cost to $429.

A third component is a front-end cabinet dealer personalized settings. With this design, the cabinet dealer personalized settings is what adjusts the cabinet selector for each individual dealer. A dealer is provided a dealer cost factor which is a percentage discount applied to List Cost. This discount factor considers the dealer’s location and is inclusive to freight costs incurred for ordered cabinetry.

A fourth component is a front-end cabinet selector dealer interface. The Cabinet Selector Dealer Interface is a graphical interface which instantly displays the cost range(s) for every Cabinet Brand available and utilized by the end-user to create a personalized cost quote instantaneously for a prospect.

At least one embodiment of the invention relates to a process for estimating a cabinet installation comprising a series of steps. In at least one step the process includes creating a cabinet brand. This cabinet brand is then stored in a database. Next, the process includes creating a basic set of floor plans and then storing these floor plans in a database. Next the process involves providing a set of stock cabinets for filling each floor plan. Next the process includes providing costs for raw materials for creating the cabinets. These costs can be stored in a database and then shown on a screen such as a webpage. Next, the process includes providing a brand cost multiplier for each brand of cabinet. This brand cost multiplier can also be stored in an associated database. Next, a user is provided with a web page where the use can then input and the system can then receive a selection of a cabinet brand. Next, the process can include receiving a selection of a layout from a user through a presentation of a blueprint or layout of a room to be furnished with cabinets. Next the process proceeds to render a furnished layout with cabinets. Next the process includes receiving a selection of at least one brand. Next, the process includes applying the brand cost multiplier to the raw material costs of the furnished layout. Next, the process includes rendering at least one price for the furnished layout based upon the brand selected.

Thus there is created a dynamic system and process for delivering estimates for a build out of a kitchen or bathroom renovation.

At least one additional embodiment can include a system for performing the process as well comprising at least one application server, at least one database server, at least one sensor, at least one data input terminal and at least one display for displaying the results of the process descried above.

### BRIEF DESCRIPTION OF THE DRAWINGS

Other objects and features of the present invention will become apparent from the following detailed description considered in connection with the accompanying drawings which disclose at least one embodiment of the present invention. It should be understood, however, that the drawings are designed for the purpose of illustration only and not as a definition of the limits of the invention.

In the drawings, wherein similar reference characters denote similar elements throughout the several views:

FIG. 1 is a schematic block diagram of a network for use with the system;

FIG. 2A is a schematic block diagram of the electronic components for the server and remote computer;

FIG. 2B is a schematic block diagram of the portable electronic device(s);

FIG. 2C is a schematic block diagram of a sensor;

FIG. 3 is a first flow chart for the process to build a brand;

FIG. 4 is a second flow chart for the process for using the brand;

FIG. 5 is a visual representation of a layout;

FIG. 6A is a screen for building a brand for a cabinet selector;

FIG. 6B is a screen for creating cabinet brands;

FIG. 7 is a screen for a build for a new kitchen profile;

FIG. 8 is a screen for a kitchen profile builder wizard;

FIG. 9 is a flow chart for the process for selecting a cabinet;

FIG. 10A is a view of a screen for configuration of cabinets;

FIG. 10B is a screen for a selection of a cabinet;

FIG. 11A is a screen for showing a price level; and

FIG. 11B is a screen for showing the selection and pricing of cabinets.

### DETAILED DESCRIPTION

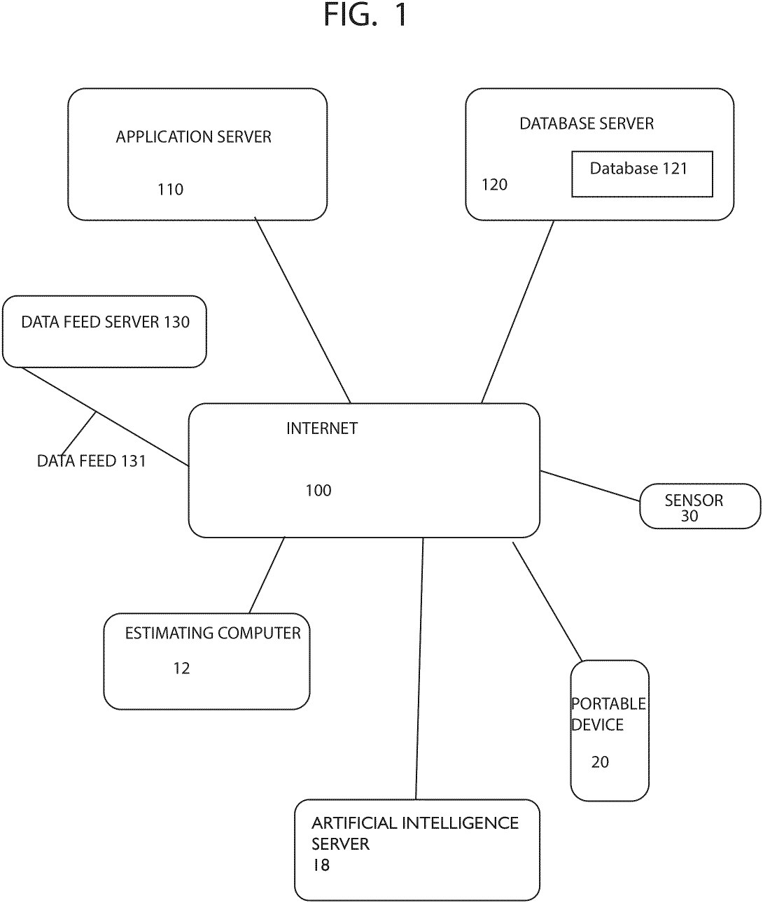

FIG. 1 is a schematic block diagram of a network for use with the system wherein there is a computer network 10 which includes the internet, as well as an estimating computer 12 as well as a portable device 20. There is also an optional sensor 30 that is also in communication with the internet 100 as well. An application server 110 is coupled to the internet 100 as well as a database server 120 having a database 121 coupled to the internet 100. Estimating computer 12 is a computer such as a personal computer which is configured to provide a computer terminal for intake of data to be put into the system. The portable device 20 can be in the form of a tablet or portable phone which can be used to allow a user to input cabinet information through a portable phone or tablet application. There is also an artificial intelligence server 18 which is configured to receive information and to assist in formulating questions. The system can also receive external data via an external data feed 131 from an external data server 130 either through web scraping or through a direct data feed such as an API. The information from this feed can then be stored in a database such as database 121 in database server 120 and then processed by application server 110. In at least one embodiment, the application server 110 processes the data from feed 131 first before it is stored in database 121 in database server 120. Alternatively the data from data feed 131 is stored in database 121 in database server 120 and then this data is processed by application server 110.

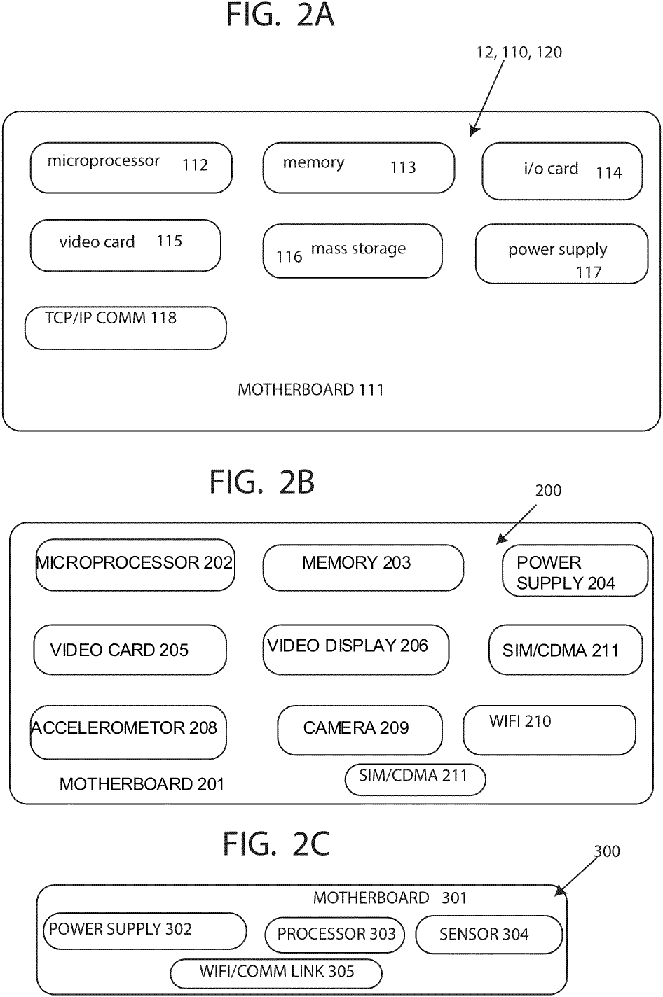

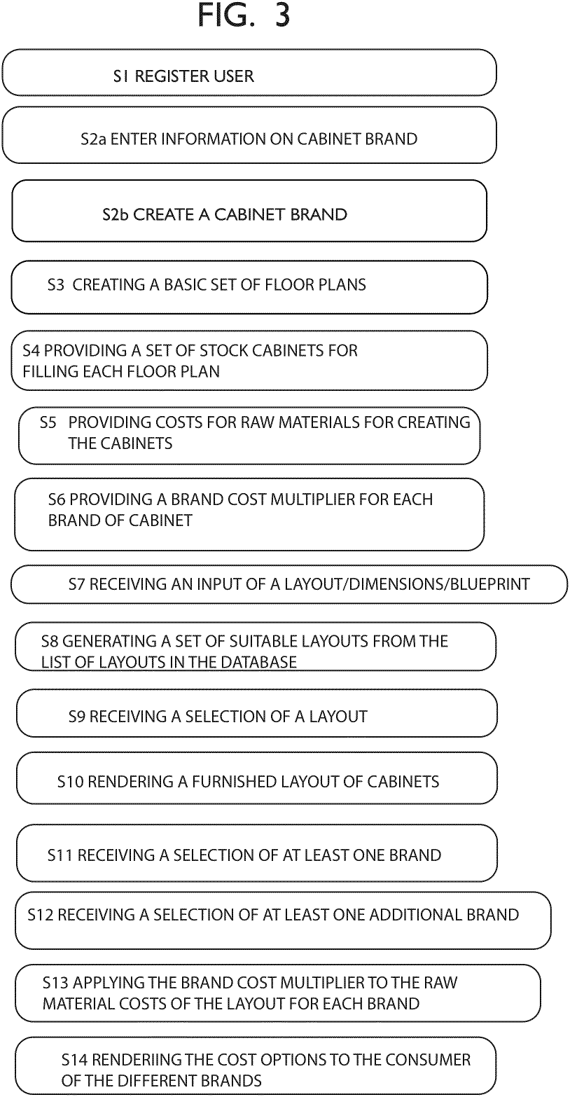

FIG. 2A is a schematic block diagram of the electronic components for the server(s) such as server 110, 18, and 120 and remote computer or estimating computer 12. For example, there is shown a motherboard 111 which is configured to house a microprocessor 112, a memory 113, an i/o card 114 or set of inputs, a video card 115, a mass storage 116, a power supply 117, a TCP/IP communications port 118. The microprocessor is configured to carry out the program flow of the process shown in FIG. 3 as well as the other series of steps. The memory 113 is configured to store the program which is configured to run on the microprocessor 112. The program can also be stored on the mass storage device 116 which is then uploaded into memory 113.

FIG. 2B is a schematic block diagram of the portable electronic device(s) such as device 20. For example, this view discloses a motherboard 201 which has a microprocessor 202 disposed thereon. There is also a memory 203, a power supply 204, a video card 205, a video display such as a screen 206, a GPS 207, an accelerometer 208, a camera 209, and a WIFI chip 210. There was also a SIM/CDMA card 211. All of these components are fed with power from power supply 204 across motherboard 201. The camera, 209, as well as the accelerometer 208 can be used to estimate the size and space of a layout. Alternatively, a sensor can be used to determine the size of the room for development with the cabinets. The sensor 30 includes a plurality of different components on a motherboard 301 (See FIG. 2C). There is a power supply 302, with a processor 303, a sensor 304 as well as WIFI/communication link 305. The sensor 304 is configured to have an optical sensor to determine the axial distance so that the proper size of the room can be determined.

FIG. 3 is a first flow chart for the process to build a brand.

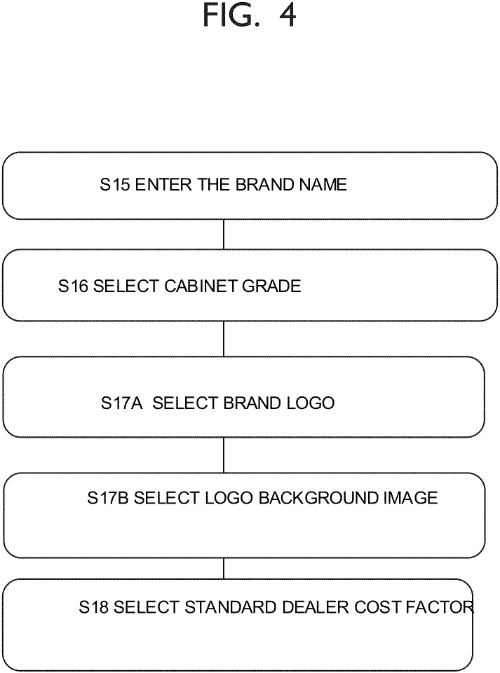

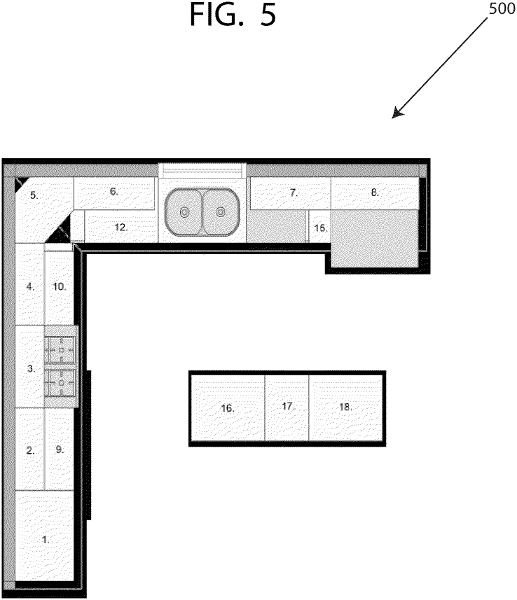

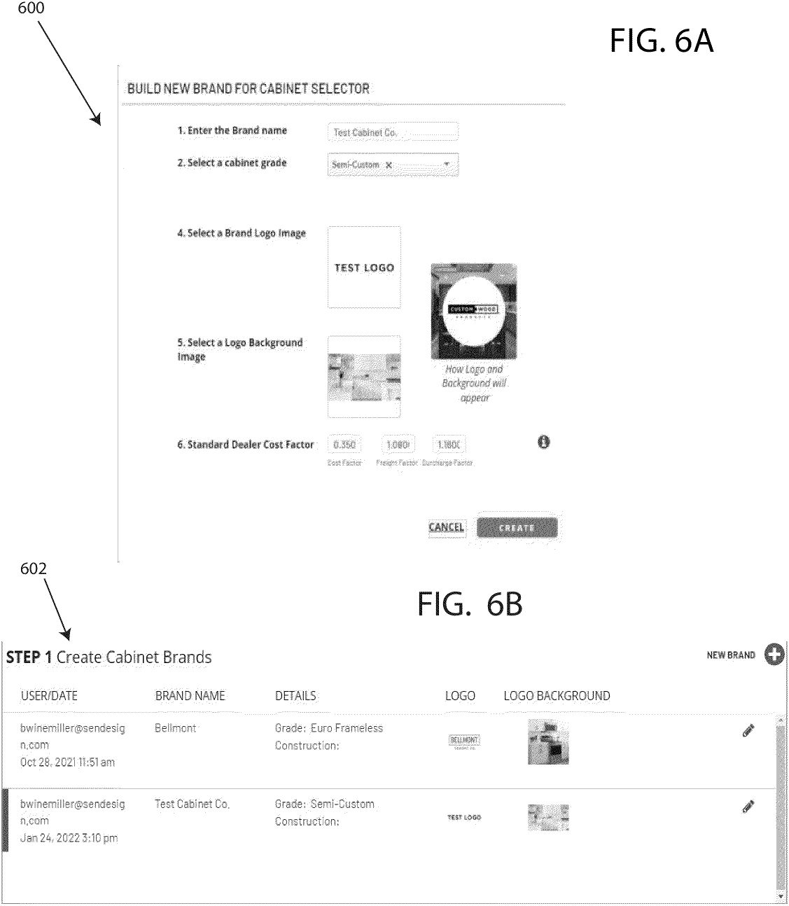

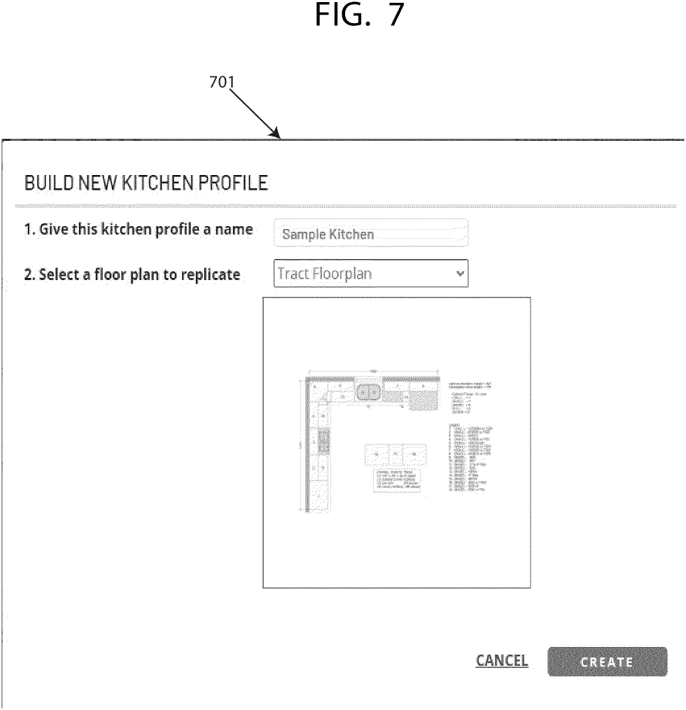

For example, the process starts in step S1 wherein the user of the system can register with the system. The user can be an overall supervisor for the system, a salesman with the system, a customer, or a distributor. Next, in step S2a if the supervisor, the distributor or the salesman registers, that person can enter in information relating to the brand. This process is shown in greater detail in FIG. 4 and is shown graphically in FIG. 6A.so that the user can eventually present a set or layout of cabinets shown in a layout 500 in FIG. 5. For example, a user can enter a brand name in a screen in FIG. 6A and shown in step S15. Next, the user can select the cabinet grade in step S16. Next, in step S17A the user can select a brand logo. Next, in step S17B the user can select a logo background image. Next in step S18 the user can select a standard dealer cost factor. The standard dealer cost factor is the multiple that the dealer puts on the price of the raw materials and fabrication costs. For example, a luxury brand may have a higher dealer cost factor than a more bargain brand. Once all of the data is entered in step S2a the user and the system can then create a cabinet brand in step 2a as shown in screen 602 in FIG. 6B.

Next, in step S3 the user can create an array of different floor plans that can eventually be selected. This array of different floor plans can be stored in a database such as in database server 120 and then called forward through queries using microprocessor 112 shown in FIG. 2A. Next, in step S4 the user can provide a set of stock cabinet for filling in each floor plan. This set of stock cabinets can include style, dimensions, wood type and any other suitable features for stock cabinets. This information can then also be stored in a database such as in database 120. Next, in step S5 the user can provide costs for raw materials for creating these stock cabinets. This information on the raw materials can be stored in a database such as in database server 120. Information such as stock cabinets and raw materials can be delivered via direct data entry by one of the users, or via an API data feed into the system so that real time pricing on raw materials and/or stock cabinets can be fed into the system and then stored into database 121.

Next, in step S6 a brand cost multiplier can be stored in a database such as with database server 120. This brand cost multiplier can be a multiplying number that can be applied to the basic raw material costs for providing the cabinetry. This brand cost multiplier can be a multiplier number such as 1.4, 1.5, 1.56, 1.6. 1.7, 1.8, 2.0 etc. Thus, as disclosed above if the cost of the raw materials of a single cabinet was 250 and the brand selected had a brand cost multiplier of 2 then the total cost for the cabinet would be $500.00. The brand cost multiplier can be based upon the multiplication factor applied to the raw materials of the product to create a final price. The raw materials can include lumber price, lumber dimension, milled style (ex. Shaker, raised panel, slab frameless, framed etc), hardware price, hardware type, wherein hardware includes drawer pulls, handles, hinges, drawer slides or any other hardware used to mount a cabinet. Other materials can include paint, stain finish etc. All of these components are input into the system so that the base material price for each cabinet is calculated and then a brand cost multiplier can be added to the base material price to determine an accurate or relatively accurate final price. There can be variables added to the calculation so that the variable can be +/_ 5% of the final price, or +/_ 7% or +/_ 10% of the final price. This variable can be set by the user so that the estimates can still be provided with a range so that the consumer is not shocked if there is a relatively small price differential between the estimated price and the actual price. Another way to determine a brand cost multiplier is to simply compare the prices or each of the finished products of each brand and then, determining the likely cost for cabinets set from each brand based upon a comparative cost multiplier. Therefore, if the good model of brand A had a cost multiplier of 1, and the good model of brand B averaged 20% higher, than brand B would have a cost multiplier of 1.2.

Next, in step S7 the system receives an input of dimensions/layout and/or blueprints from the user. This information could also be stored in a database such as in database 120. From this set of dimensions, a series of appropriate layouts can be discovered in the database and then offered to a user in step S8. This discovery relies on a first analysis of the blueprint layout, the layout (size, shape, obstructions, plumbing, door or window locations, appliance locations etc) is then considered before matching each component with a pre-set layout. If the original blueprints are too different from a pre-set layout the user will be prompted to add and additional layout graphically into the system so that this new layout is used to calculate the number and size of cabinets necessary for the layout.

Thus, based upon the dimensions presented and any blueprints or requirements, the list of pre-set layouts would be narrowed down for the user so that a user would only be presented with a limited list of layouts for cabinets which would fit in this space. This calculation of suitable layouts would be based upon the size, (area, length, width) of the layout, the geometry (shape) of the layout as well as any pre-conditions for the layout such as using an island, double wide refrigerator, a doorway etc.

From these different layouts presented to the user, next in step S8, the system would receive a selection of a layout from a user in step S9. This layout would be such as a layout shown in FIG. 5. This layout can be a replication of a floor plan is a selection of a floor plan based upon the dimensions recorded by a user and then input into the system. If the measurements of the floor space are of a sufficient dimension, then a pre-approved floor plan having a pre-set layout can then be used to populate that space. Once the replicated floor space is created from a database of previously outlined floor spaces, then a user can populate the cabinets in the floor space with a particular brand.

Next in step S10 the system renders a furnished layout of the cabinets for the layout. Next, in step S11 the user would select at least one brand which can be selected from the list of brands that were created by brand suppliers and stored in a database such as database 120. Next, in step S12 the system would receive a selection of at least one additional brand for use by the user.

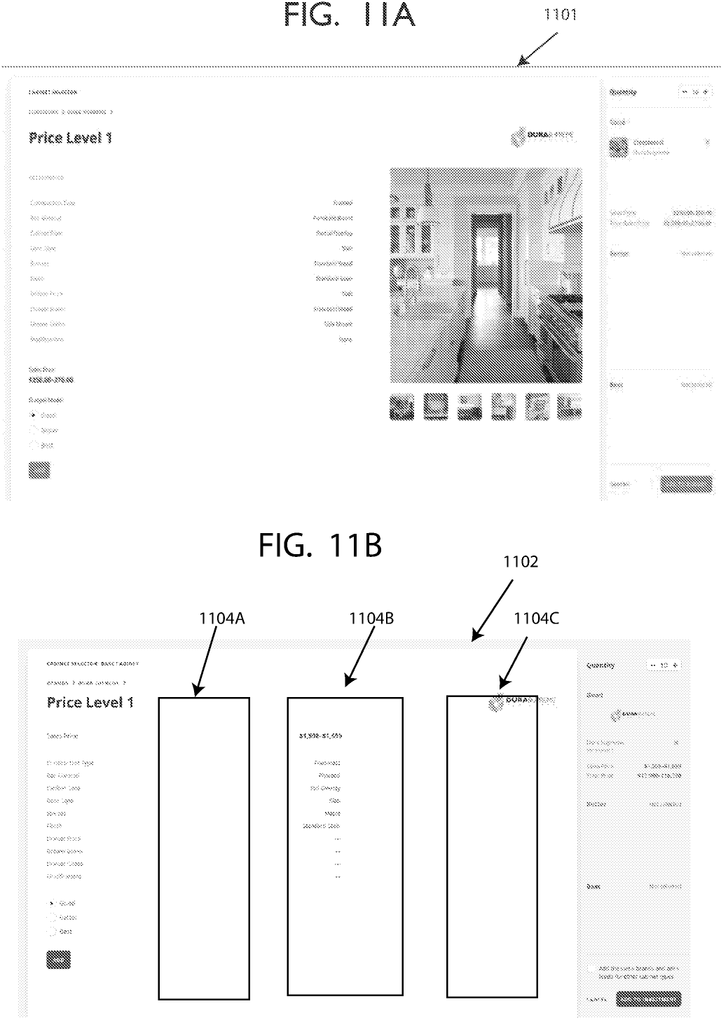

Next, in step S13, the system and particularly microprocessor 112 would then calculate the cabinetry raw costs for these brands. This would be calculated based upon the type of materials used such as the base stock wood, the finish and coatings, as well as the style and hardware used. The dimension as well as the number of cabinets would also be used to calculate these raw costs. Next, once the raw costs are applied, in this step the standard dealer cost factor is applied to this set of raw costs. As indicated above the standard dealer cost factor could be a cost factor such as 1.5, 2.0 or some multiple of the cost of the raw materials which are then marked up based upon the brand of the cabinetry that is used. Next, in step S14 the system renders the cost options to the consumer for at least two options or brands such as that shown in FIG. 11B.

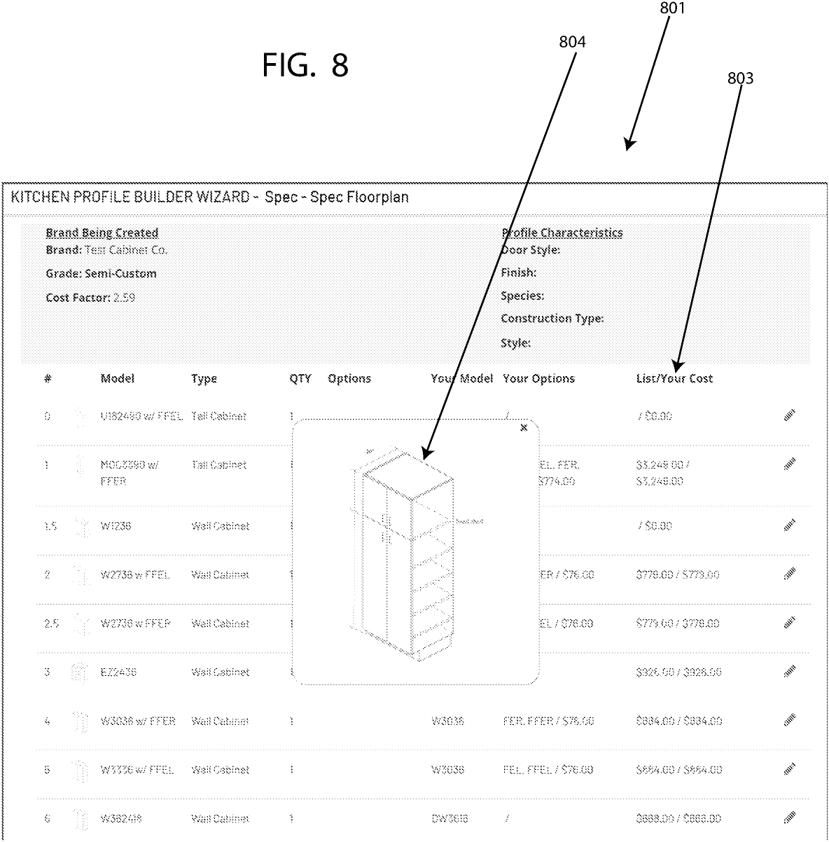

FIG. 8 is a screen for a kitchen profile builder wizard 801. This kitchen profile builder wizard screen includes a series of different components which can be itemized, provided with a final cost 803 as well as an image 804.

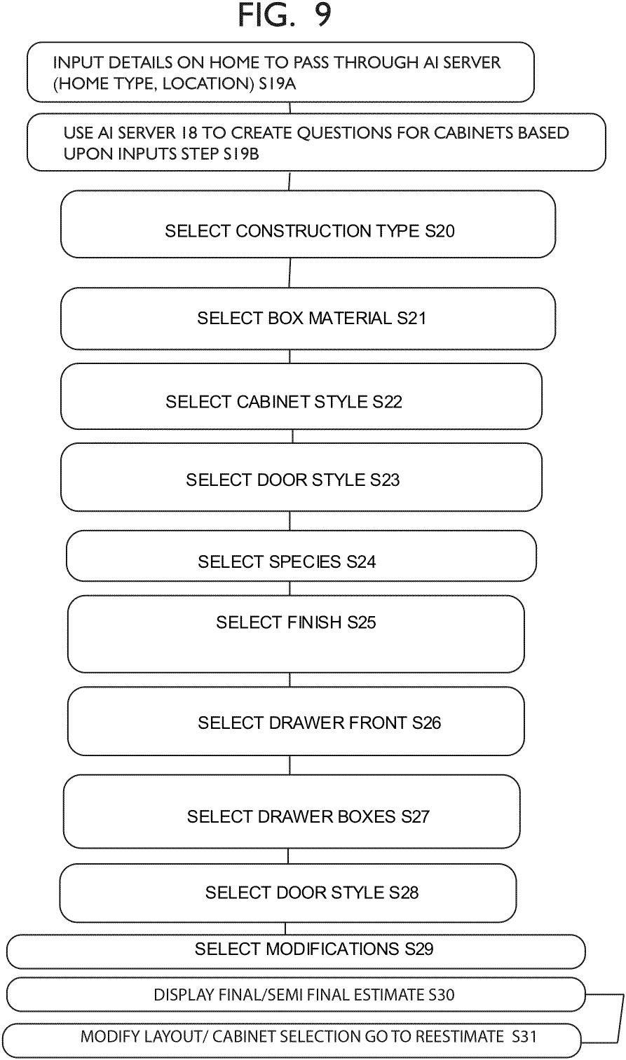

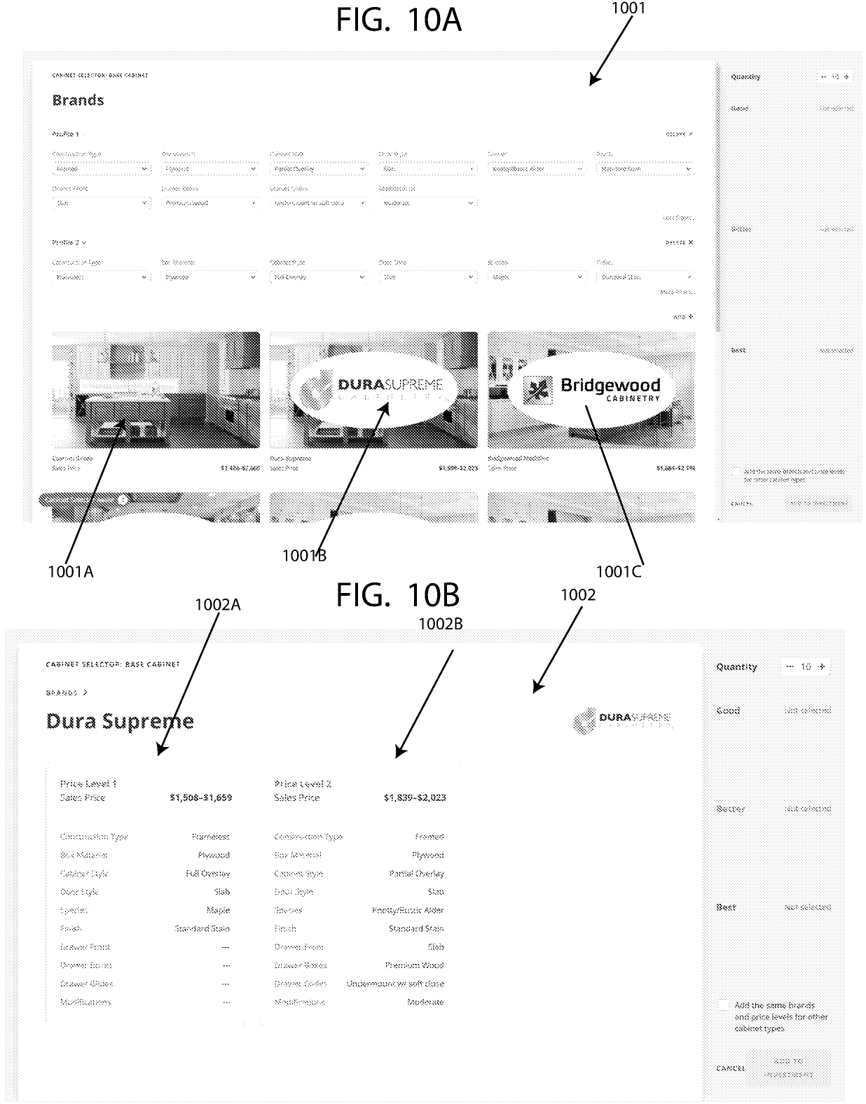

FIG. 9 is a flow chart for the process for selecting a particular cabinet or cabinet style for a layout. For example, the process starts in step S19A wherein information is input into AI server 18. The information that is input is taken in from the users such as the customers or via agents providing the service. This information would be input into either an estimating computer 12 or into a portable device 20, and then transported through the internet 100 to artificial intelligence server 18. In step S19A the information input includes details on the home such as home type, location etc. Next, in step S19B the AI server creates questions to determine the type, amount and style of the cabinets based upon the inputs in step S19b. Next, if any of these questions or answers are not calculated in steps S19A and S19B the process proceeds to step S20 wherein the user can select the construction type S20. The construction type could be any suitable construction type such as “framed” “unframed” etc. Next, the user can select a box material S21 such as plywood or furniture board (See also FIG. 10A). Next, the user can select the door style in step S23, such as slab or shaker or any other style. Next, in step S24 the user can select the species. Next, in step S26, the user can select the finish. The finish can be painted, stained or any other type of suitable finish. Next, in step S26, the user can select the drawer front. The drawer front can be any one of a style for a drawer front such as slab, shaker or any other type of drawer front. Next, in step S27 the user can select the drawer boxes. The type of material that is used for drawer boxes could be anything from manufactured wood to standard wood (plywood) to wood grain. Next, in step S28, the user can select the door style, the door style can be any style such as that listed above. Next, in step S29, the user can select any modifications. Once all of the features and components have been selected for each of the cabinets, or for multiple iterations of cabinets, the system then applies the dealer cost factor to multiply the cost of the cabinetry raw costs to render a final price for each of the cabinets. Thus, a final listing of at least two sets of cabinets is shown in FIG. 10B which shows a first set of cabinets and a second set of cabinets in step S30. If the user such as the customer does not like the final output via price, the in step 31 user such as the salesman, customer, or system supervisor can change the layout of the cabinets to alter the price. Then the process reverts back to step S30 where the new rendering of the price and layout is delivered to the user.

The view in FIG. 10A shown by screen 1001 shows a selection of cabinets which are taken from the thousands or millions of possible permutations which can be crated from the database such as a database 121 in database server 120. FIG. 10A shows a filtered set of permutations with the remaining permutations filtered out by a microprocessor such as microprocessor 112 in application server 110. The resulting rows in FIG. 10A provide the cost range. When the cost range exceeds the threshold of variance set by the end-user the system breaks the possible investment in to price levels. Each price level has a pre-sent threshold variance. In one embodiment the variance is 5%. In another embodiment, the variance is 8% in another embodiment the variance is 10%. Any suitable variance can be pre-set in this instance. Thus, at the end of each variance level it breaks these variance levels into different price levels such as good/ better/ best. At each price level there is a listing such as at a “good” price level show in section 1001a, a “better” price level shown by section 1001b, or a “best” price level shown by section 1001c shown in FIG. 10A.

FIG. 10B is a screen for a selection of a set of cabinets based upon initial price levels. For example, in this screen 1002 there are shown two selections 1002a and 1002b. A first selection 1002a is set at a first price level based upon an initial set of specifications. The second selection 1002b is at a second price level which includes a different level of style and materials.

FIG. 11A is a screen for showing a price level for another set of cabinets in screen 1101.

Finally FIG. 11B is a screen 1102 for showing the selection and pricing of cabinets placed side by side showing a set of three price ranges of Good in area 1104a / Better in area 1104b / and Best in area 1104c in terms of quality and price.

With this process, every step up until FIG. 10A explains how the raw cabinetry costs and cabinet customization factors are reached for each provisioned brand. This would be considered backend data provisioning. The system then uses factorial math within its algorithms, along with what is called an “exceptions matrix” (prevents incompatible customizations from being combined) to create millions of possible permutations. FIG. 10A -is what the end user professional uses, typically interactively with the homeowner or end-consumer to instantly reach the comparative good, better, best estimates across numerous brands and/or cabinet series.

Thus, because of this process the user is rapidly provided with a set of estimates for a construction project for a kitchen or a bathroom so that the different renderings of the costs, and style and types of cabinets can be rapidly and accurately presented to a user such as a customer, so that the customer can then make a rapid but accurate decision regarding the fit, style and cost of their cabinetry.

Accordingly, while at least one embodiment of the present invention have been shown and described, it is to be understood that many changes and modifications may be made thereunto without departing from the spirit and scope of the invention as defined in the appended claims.

What is claimed is:

1. A process for estimating a cabinet installation comprising the steps of:
creating a cabinet brand;
creating a basic set of floor plans;
providing a set of stock cabinets for filling each floor plan;
providing costs for raw materials for creating the cabinets;
providing a brand cost multiplier for each brand of cabinet;
receiving a selection of a cabinet brand;
receiving a selection of a layout;
rendering a furnished layout with cabinets;
receiving a selection of at least one brand;
applying said brand cost multiplier to the raw material costs of the furnished layout; and
rendering at least one price for the furnished layout based upon the brand selected.

2. The process as in claim 1, further comprising the step of storing each cabinet brand in a database.

3. The process as in claim 1, further comprising the step of storing a cost for raw materials for cabinet parts in a database.

4. The process as in claim 1, further comprising the step of storing a plurality of floor plans in a database.

5. The process as in claim 1, further comprising the step of selecting at least one additional brand and rendering at least a second price for the furnished layout based upon the second brand selected.

36. The process as in claim 1, further comprising the step of selecting at least a third brand, and then rendering at least a third price for the third brand.

7. The process as in claim 1, further comprising the step of providing a feed for real time updating of raw materials.

8. The process as in claim 1, wherein said step of providing a brand cost multiplier comprises inputting data into a database for average costs for each model of each brand.

9. Th process as in claim 1, wherein said step of providing a brand cost multiplier comprises calculating an average difference between each brand by averaging the cost of each model for each brand, determining the amount of raw materials in each model of each brand and then determining a brand cost multiplier based upon the cost difference between the raw materials and the total cost of a finished product.

10. The process as in claim 1, wherein the step of providing a set of stock cabinets comprises providing a set of pre-set dimensions for different sized cabinets.

11. The process as in claim 10, wherein the step of providing a set of stock cabinets comprises providing a set of cabinets of different shape.

12. The process as in claim 10, wherein the step of providing a set of stock cabinets comprises providing a location for each cabinets including a location of each cabinets in either an upper cabinet position or under counter position.

13. The process as in claim 1, wherein the step of editing the rendering of the cabinet layout.

14. The process as in claim 13, wherein the step of editing the rendering of the cabinet layout further comprises changing the cost estimate for at least one brand based upon the changed layout.

15. The process as in claim 1, further comprising inputting data including at least the floor plan, and the brand cost multiplier into an artificial intelligence (AI) server.

16. The process as in claim 15, further comprising the step of inputting a set of stock cabinets into the AI server.

17. The process as in claim 16, further comprising the step of inputting the layout into the AI server.

18. The process as in claim 17, wherein said AI server is configured to provide questions to a consumer to gather information for providing a final cabinet layout.

19. A system for estimating a cabinet installation comprising:
at least one database server having at least one microprocessor, said at least one database server for storing a database;
at least one application server having at least one microprocessor;
at least one sensor having at least one microprocessor, said sensor configured to observe, determine and record dimensional data of at least one room into the at least one database server;
at least one data input terminal having at least one microprocessor, said data input terminal for inputting data into the system, wherein said at least one application server is configured to determine a total number, and type of cabinets necessary based upon a layout of a cabinet installation based upon dimensional data of said at least one sensor, and to determine a cost of a cabinet installation based upon a pre-set price of cabinets stored in said at least one database, and then render both a final cabinet layout with pricing for at least one set of cabinets for said final cabinet layout.

20. The system as in claim 19, wherein the application server is configured to determine a price of the layout based upon a brand multiplier stored in said application server and wherein the application server is configured to determine a price of an additional layout of an additional model for cabinets to provide a user with a price option for a selection of cabinets.
